(19) United States
(12) Patent Application Publication
(10) Pub. No.: US 2015/0328968 A1
(43) Pub. Date: Nov. 19, 2015

(54) Side View Mirror Cover

(71) Applicant: Robert Barber, Morrisville, PA (US)

(72) Inventor: Robert Barber, Morrisville, PA (US)

(21) Appl. No.: 14/710,913

(22) Filed: May 13, 2015

Related U.S. Application Data
(60) Provisional application No. 61/992,444, filed on May 13, 2014.

(51) Int. Cl. B60J 11/06; G02B 27/00; G02B 5/08

(52) U.S. Cl. CPC B60J 11/06; G02B 5/08; G02B 27/0006

(57) ABSTRACT

A cover for a side view mirror adapted to prevent precipitation such as snow or ice from accumulating thereon. The cover includes a pouch having a closed end, and open end, and an interior volume. The cover is sized so as to fit securely onto the side view mirror and fully encloses the same. The open end includes an elastic element therearound for use in securing the pouch onto a side view mirror, so that the pouch does not fall or slip off of the side view mirror. The pouch may be transparent and waterproof. Further, the pouch may include one or more layers, wherein an inner layer is insulative and an outer layer is waterproof. In this way, the present invention prevents precipitation from accumulating on the side view mirror.

### CROSS REFERENCE TO RELATED APPLICATION

This application claims the benefit of U.S. Provisional Application No. 61/992,444 filed on May 13, 2014. The above identified patent application is herein incorporated by reference in its entirety to provide continuity of disclosure.

### BACKGROUND OF THE INVENTION

### Field of the Invention

The present invention relates to protective covers for vehicles. More specifically, the present invention provides a cover for a side view mirror of a vehicle comprising a pouch having a closed end, an open end, and an interior volume, wherein the pouch is adapted to receive a side view mirror of a vehicle therein. The opening preferably comprises an elastic element that can be stretched so as to fit snugly onto side view mirrors of different shapes and sizes.

Precipitation, such as snow or ice, can accumulate on the side view mirrors of vehicles during periods of cold weather. While people commonly remove snow and ice from their vehicles prior to driving, it can be difficult to fully remove snow and ice from side view mirrors due to their shape and location. The surface of the mirror may be too small for a conventional ice scraper to be used to remove snow or ice therefrom. Further, the side view mirrors can be damaged if the person does not carefully remove ice and snow therefrom. As a result, many people may drive their vehicles without properly removing precipitation from side view mirrors. However, this can be dangerous since the driver's vision is impaired, and the driver may fail to see other vehicles in the nearby area. Thus, a device for covering a side view mirror so as to prevent the accumulation of snow or ice thereon is desired.

Devices have been disclosed in the prior art that relate to vehicle covers. These include devices that have been patented and published in patent application publications. These devices generally relate to attachments for vehicle mirrors. U.S. Pat. No. 6,325,121, U.S. Published Patent Application Number 2010/0326017, and U.S. Pat. No. 5,115,848 provide protective covers having drawstrings or straps for securing the cover on a vehicle or vehicle component. U.S. Design Pat. D692,821, U.S. Design Pat. D672,304, and U.S. Design Pat. D662,030 relate to ornamental designs for vehicle mirror covers.

These prior art devices have several known drawbacks. The devices in the prior art relate to covers for vehicle windows and mirrors, but fail to disclose covers that fully enclose the side view mirror of a vehicle. Such devices further fail to disclose an elastic element disposed around the opening of the cover for securing the cover in position on a vehicle mirror. Thus, the devices in the prior art do not adequately prevent precipitation from accumulating on a side view mirror of a vehicle.

In light of the devices disclosed in the prior art, it is submitted that the present invention substantially diverges in design elements from the prior art and consequently it is clear that there is a need in the art for an improvement to existing vehicle cover devices. In this regard the instant invention substantially fulfills these needs.

### SUMMARY OF THE INVENTION

In view of the foregoing disadvantages inherent in the known types of vehicle mirror covers now present in the prior art, the present invention provides a new side view mirror cover wherein the same can be utilized for providing convenience for the user when protecting a side view mirror from the accumulation of precipitation, such as snow or ice thereon.

It is therefore an object of the present invention to provide a new and improved side view mirror cover device that has all of the advantages of the prior art and none of the disadvantages.

It is another object of the present invention to provide a side view mirror cover comprising a pouch having a closed end, an open end, and an interior volume adapted to receive a side view mirror therein.

Another object of the present invention is to provide a side view mirror cover comprising a pouch having an open end with an elastic element therearound for securing said pouch onto the side view mirror of a vehicle.

Yet another object of the present invention is to provide a side view mirror cover that is composed of a transparent and waterproof material.

Another object of the present invention is to provide a side view mirror cover that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the side view mirror cover.

FIG. 2 shows a cross sectional view of the side view mirror cover.

FIG. 3 shows a perspective view of the side view mirror cover as positioned for installation on a side view mirror.

### DETAILED DESCRIPTION OF THE INVENTION

Reference is made herein to the attached drawings. Like reference numerals are used throughout the drawings to depict like or similar elements of the side view mirror cover. For the purposes of presenting a brief and clear description of the present invention, the preferred embodiment will be discussed as used for protecting the side view mirror of a vehicle from precipitation. The figures are intended for representative purposes only and should not be considered to be limiting in any respect.

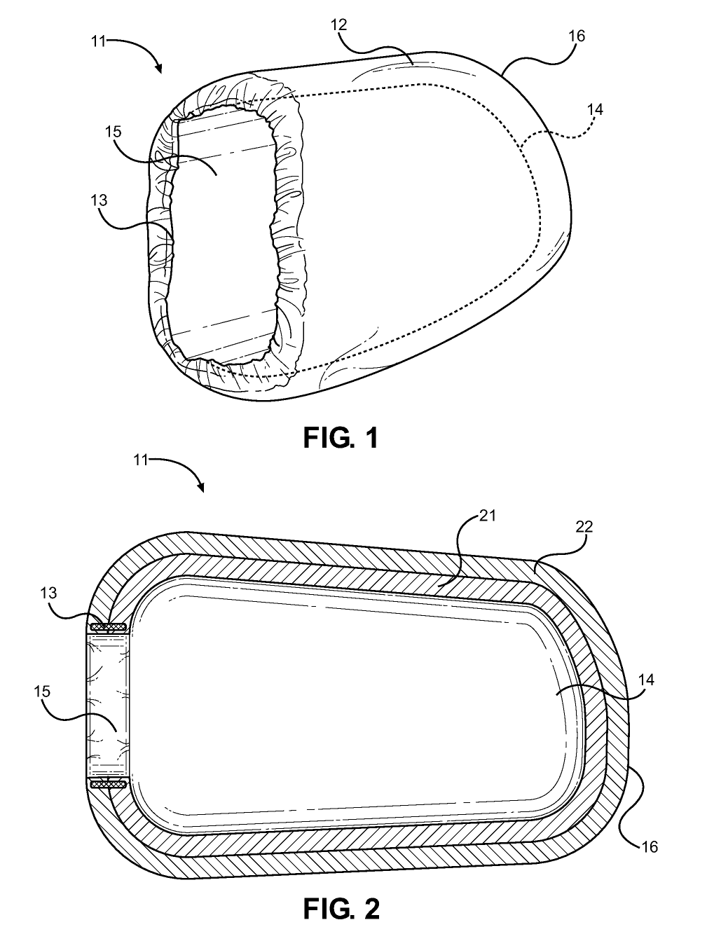

Referring now to FIG. 1, there is shown a perspective view of the side view mirror cover. The side view mirror cover 11 comprises a pouch 12 having a closed end 16, an open end 15, and an interior volume 14. The interior volume 14 is adapted to receive a side view mirror of a vehicle therein. Preferably, the pouch 12 is shaped similarly to a side view mirror of a vehicle so as to fit snugly thereon. The pouch 12 is composed of a flexible material so as to fit to the shape of various vehicle side view mirrors.

The open end 15 of the pouch 12 includes an elastic element 13 therearound. Thus, the elastic element 13 is positioned about the perimeter of the open end 15 of the pouch 12. The elastic element 13 is adapted to stretch over the side view mirror during installation so that the pouch 12 can be positioned over the side view mirror. The elastic element 13 secures the pouch 12 into position on the side view mirror so that the pouch 12 does not blow away during harsh weather conditions nor does it otherwise slip or fall off of the side view mirror of a vehicle. Thus, the pouch 12 fully encloses the side view mirror of the vehicle to as to prevent snow or ice from accumulating thereon.

Referring now to FIG. 2, there is shown a cross sectional view of an embodiment of the side view mirror cover. In the illustrated embodiment, the side view mirror cover 11 comprises an inner layer 21 and an outer layer 22. The inner layer 21 is coextensive with the outer layer 22 and the layers 21, 22 may be secured together via any suitable fastening means such as stitching or adhesives, among others. The inner layer 21 comprises an insulating material, and the outer layer 22 comprises a waterproof material. The outer layer 22 serves to prevent precipitation from soaking through the pouch 12 and causing the pouch 12 to freeze or otherwise become stuck to the side view mirror.

In alternative embodiments, the side view mirror cover 11 comprises a single layer. The single layer is preferably waterproof so as to prevent precipitation from passing therethrough and contacting the side view mirror covered by the side view mirror cover 11. Further, the single layer may be transparent so that the user can see the side view mirror through the side view mirror cover 11.

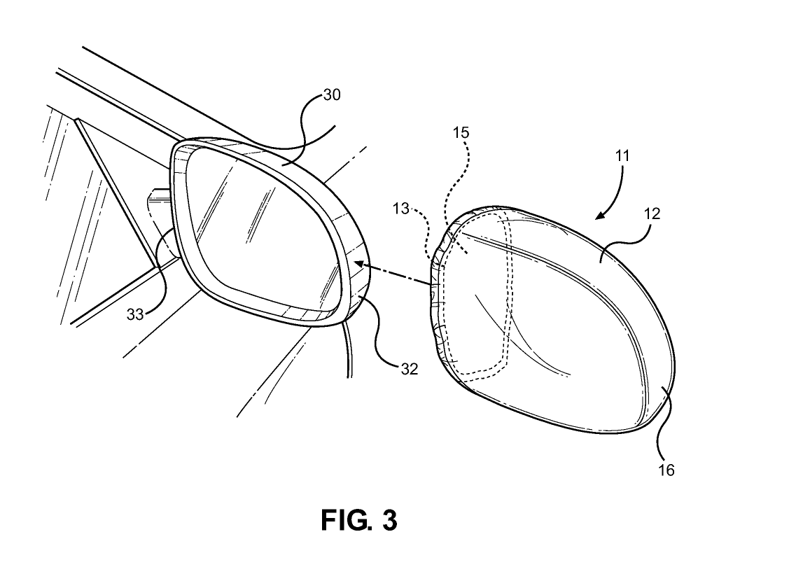

Referring now to FIG. 3, there is shown a view of the side view mirror cover as positioned for installation on a side view mirror. The side view mirror cover 11 can be positioned so that the open end 15 of the cover receives the outer side 32 of the side view mirror 30. The side view mirror cover 11 can be moved towards the vehicle as it passes over the side view mirror 30 until the side view mirror 30 is fully enclosed within the interior volume of the pouch 12. The elastic element 13 is adapted to stretch over the side view mirror 30 and fits snugly onto the first side 33 of the side view mirror 30. When installed, the closed end 16 of the pouch 12 rests against the outer side 32 of the side view mirror 30. In this way, the side view mirror cover 11 can be easily installed and removed by a user, and serves to protect the side view mirror 30 from having snow or ice accumulate thereon. Further, the elastic element 13 helps to prevent the side view mirror cover 11 from falling or slipping off of the side view mirror 30.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cover for side view mirrors, comprising:
a pouch having an open end, a closed end, and an interior volume adapted to receive a side view mirror of a vehicle therein;
wherein said open end comprises an elastic element therearound, wherein said elastic element is adapted to fasten said pouch onto said side view mirror.

2. The cover for side view mirrors of claim 1, wherein said pouch comprises an inner layer and an outer layer, said outer layer composed of a waterproof material.

3. The cover for side view mirrors of claim 2, wherein said inner layer comprises an insulating material.

4. The cover for side view mirrors of claim 1, wherein said pouch is transparent.

5. The cover for side view mirrors of claim 1, wherein said pouch is composed of a waterproof material.
